(19) United States
(12) Patent Application Publication
(10) Pub. No.: US 2012/0162618 A1
(43) Pub. Date: Jun. 28, 2012

(54) SUBSTRATE PROCESSING DEVICE AND METHOD

(75) Inventors: Masaru TOKUMARU, Miyazaki (JP); Toshikazu YAMAUCHI, Miyazaki (JP)

(73) Assignee: LAPIS SEMICONDUCTOR CO., LTD., Tokyo (JP)

(21) Appl. No.: 13/332,609

(22) Filed: Dec. 21, 2011

(30) Foreign Application Priority Data
Dec. 28, 2010 (JP) 2010-293515

(51) Int. Cl. G03B 27/32

(52) U.S. Cl. 355/27

(57) ABSTRACT

A semiconductor processing device sprays a liquid chemical agent onto a film on a spinning semiconductor substrate. The spray nozzle is moved horizontally from a first upper position comparatively distant from the substrate to a second upper position closer to the substrate, then vertically downward to a lower position. All of these positions are higher than the substrate and none of them overlie the substrate. The spray nozzle is then moved horizontally to a spray position over the substrate and spraying begins. Any residual liquid chemical agent remaining at the outlet of the spray nozzle from the processing of a previous substrate drops off harmlessly at the end of the downward vertical motion instead of dropping onto the film on the substrate.

### BACKGROUND OF THE INVENTION

1. Field of the Invention

The present invention relates to a substrate film processing technology using a liquid agent.

2. Description of the Related Art

Semiconductor manufacturing processes often include the formation of a resist pattern on a wafer by photolithography, for use as an etching mask, for example. The photolithography process generally includes a step of forming a photosensitive resin film by applying a photosensitive resin material (photoresist) to the preprocessed wafer surface and drying the film, a step of exposing the photosensitive resin film to light through a mask, thereby transferring the mask pattern onto the photosensitive resin film, and a step of developing the transferred pattern by using a liquid chemical agent referred to as a developer that selectively dissolves the resin film. Known developing methods include a spray developing method and a dip developing method. In Japanese Patent Application Publication No. 2007-134367, Fukui et al., discloses a spray developing method in which developer is discharged from the tip of a spray nozzle at high pressure onto the surface of the photosensitive resin film.

The spray developing method is problematic in that when the same spray nozzle is used continuously to develop a plurality of wafers, residual developer remaining around the outlet at the nozzle tip may drip onto the photosensitive resist film. The residual developer has deteriorated due to exposure to air, so if residual developer drips onto the photosensitive resist film before fresh developer, it may cause development faults. Resultant problems include uneven film thickness and lowered dimensional precision of the resist pattern. The dimensions of small holes in the resist pattern are particularly apt to be affected.

### SUMMARY OF THE INVENTION

An object of the present invention is to provide a substrate processing device and method that can prevent a liquid chemical agent such as a developer remaining at or around the tip of a spray nozzle from dropping onto a film to be processed on the substrate.

The invention provides a novel substrate processing method for use in a substrate processing device having a spray nozzle for discharging a liquid chemical agent to process a film on a substrate, a nozzle moving mechanism for moving the spray nozzle vertically and horizontally relative to the substrate, and a rotational driving unit for spinning the substrate.

In the novel method, the nozzle moving mechanism moves the spray nozzle horizontally from a first upper position to a second upper position, both higher than the substrate and neither overlying the substrate. The second upper position is closer than the first upper position to the substrate.

Next, the nozzle moving mechanism moves the spray nozzle vertically downward from the second upper position to a lower position that is lower than the second upper position and higher than the substrate.

Then the nozzle moving mechanism to moves the spray nozzle horizontally from the lower position to a spray position directly over the substrate.

The invention also provides a novel substrate processing device including a supporting member for supporting a substrate coated with a film, a rotational driving unit for spinning the substrate, a spray nozzle for spraying a liquid chemical agent for processing the film, a nozzle moving mechanism for moving the spray nozzle horizontally and vertically relative to the supporting member, a spray controller for controlling the spraying of the liquid chemical agent from the spray nozzle toward the film, a rotational controller for controlling the rotational driving unit, and a spray nozzle motion controller that controls the nozzle moving mechanism according to the novel method.

Moving the spray nozzle vertically downward from the second upper position to the lower position tends to release any residual liquid chemical agent remaining at the tip of the spray nozzle harmlessly, before the nozzle travels over the substrate. The residual liquid chemical agent accordingly does not drop onto the substrate.

### BRIEF DESCRIPTION OF THE DRAWINGS

In the attached drawings:

FIG. 1 is a schematic block diagram illustrating the general structure of a developing device exemplifying a substrate processing device according to a first embodiment of the invention;

FIG. 2 is a partial plan view of the developing device shown in FIG. 1;

FIG. 3 is a schematic timing diagram illustrating an exemplary development sequence employed by the developing device in FIG. 1;

FIGS. 4A and 4B schematically illustrate the outward path of travel of the spray nozzle in FIG. 1;

FIGS. 5A and 5B schematically illustrate the developer spray pattern;

FIG. 6 schematically illustrates the homeward path of travel of the spray nozzle in FIG. 1;

FIG. 7 schematically illustrates the outward path of travel of the rinse nozzle in FIG. 1;

FIG. 8 is a schematic timing diagram illustrating an exemplary development sequence employed in a second embodiment of the invention; and

FIG. 9 is a schematic timing diagram illustrating an exemplary development sequence employed in a third embodiment.

### DETAILED DESCRIPTION OF THE INVENTION

Novel substrate processing devices and methods will now be described with reference to the attached drawings, in which like elements are indicated by like reference characters. Directional reference axes are indicated by the letters X and Y (horizontal) and Z (vertical).

### First Embodiment

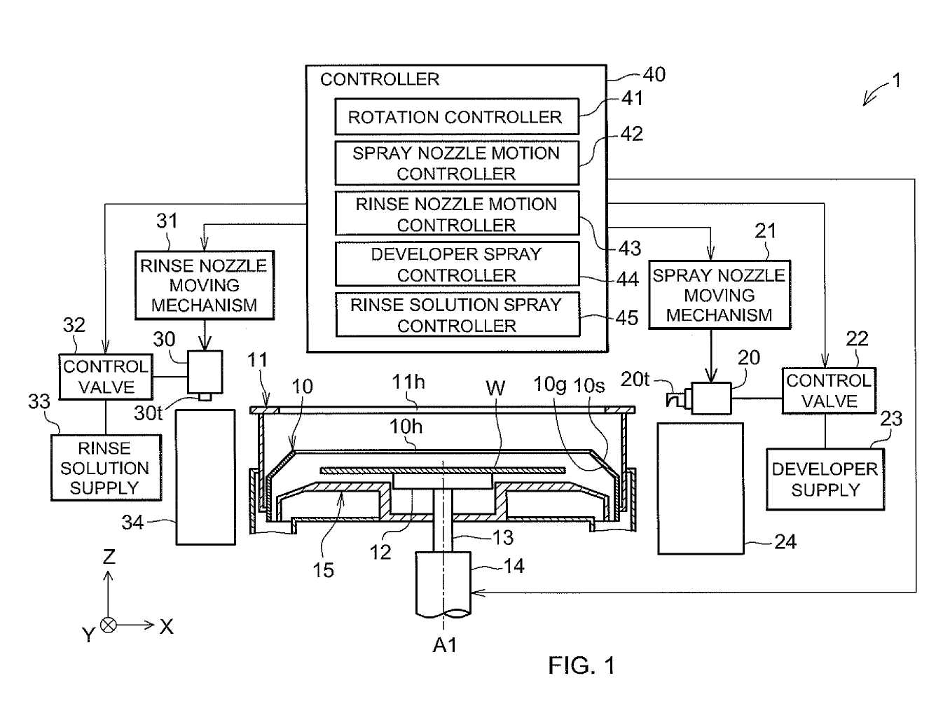

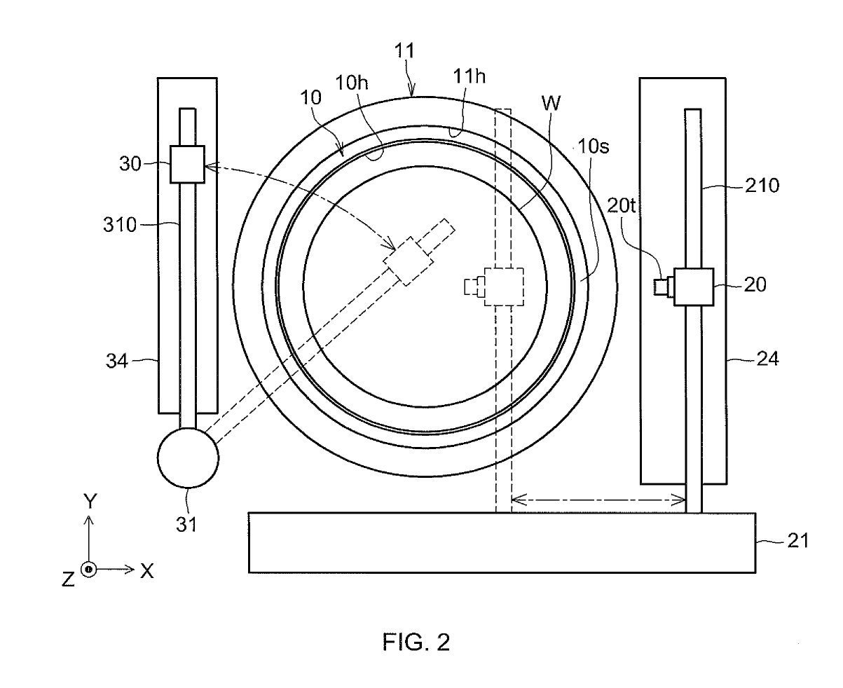

The structure of the novel substrate processing device according to the first embodiment of the invention will be described with reference to FIGS. 1 and 2. This substrate processing device is the developing device 1 in FIG. 1. The substrate is a semiconductor wafer W. The main components of the developing device 1 are an inner cup or baffle 10, an outer cup or annular member 11, a spin chuck 12, a rotational shaft 13, a rotational driving mechanism 14, a drain plate 15, a spray nozzle 20, a spray nozzle moving mechanism 21, a control valve 22, a developer supply 23, a pair of standby pods 24, 34, a rinse nozzle 30, a rinse nozzle moving mechanism 31, a control valve 32, a rinse solution supply 33, and a sequence controller 40, referred to below simply as a controller. The controller 40 includes a rotation controller 41, a spray nozzle motion controller 42, a rinse nozzle motion controller 43, a developer spray controller 44, and a rinse solution spray controller 45.

The developing device 1 uses a spray-drying method to develop a photosensitive resin film (not shown) formed on the upper surface of the wafer W. The photosensitive resin film is a resist film formed by, for example, spin coating. The resist film has been exposed to light through a mask before the wafer W is transferred into the developing device 1, and already bears the mask pattern in a latent form.

The wafer W is surrounded by the inner cup 10, which is nested within the outer cup 11. The upper part of the inner cup 10 has inner and outer sloping surfaces 10g, 10s surrounding a top opening 10h. The inner and outer sloping surfaces 10g, 10s slope down and outward from the top opening 10h, thus down and away from the wafer W.

The outer cup 11 has a top opening 11h. The diameter of this top opening 11h is greater than the diameter of the top opening 10h of the inner cup 10, which in turn is greater than the diameter of the wafer W.

The spin chuck 12 supports the wafer W horizontally by vacuum attraction at substantially the center of the lower surface of the wafer W, holding the upper surface of the wafer W perpendicular to the Z-axis direction. The rotational driving mechanism 14 includes a motor (not shown) driven under control of the rotation controller 41 in the controller 40. The motor turns the rotational shaft 13, which is connected to the spin chuck 12, about its central axis A1, thereby spinning the wafer W. The rotational speed of the wafer W is controlled by the rotation controller 41.

As described later, developer and rinse solutions are sprayed onto the surface of the wafer W through the top openings 10h and 11h of the cups. The inner sloping surface 10g of the inner cup 10 is tilted downward at an angle of about forty-five degrees (45°) with respect to the surface of the wafer W so that any developer or rinse solution thrown from the spinning wafer W onto the inner sloping surface 10g splatters downward onto the drain plate 15.

The drain plate 15 is disposed below the wafer W and surrounds the spin chuck 12 and rotational shaft 13 as shown in the cross-sectional view in FIG. 1. Developer or rinse solution falling from the inner sloping surface 10g of the inner cup 10 or dripping down from the edge of the wafer W collects on the drain plate 15, flows outward, and exits through an external drainage outlet (not shown). Also provided below the wafer W, although not shown in the drawings, are an air exhaust duct and a lower-surface rinse spray nozzle for spraying the lower surface of the wafer W with rinse solution.

Before the start of developing, the spray nozzle 20 is raised from its standby pod 24 to a standby position as shown in FIG. 1. During developing, the spray nozzle 20 moves to a position over the wafer W, receives the developer solution under high pressure through the control valve 22 from the developer supply 23, and sprays the liquid chemical agent downward from an outlet at its tip 20t. The rate of discharge of the developer solution is adjusted by the control valve 22, which operates under control of the developer spray controller 44 in the controller 40. The developer solution is a liquid chemical agent that dissolves the unexposed (for a negative resist film) or exposed (for a positive resist film) portions of the photosensitive resin film depending on whether or not they have been exposed to the light. Tetra-methyl ammonium hydroxide (TMAH) or another aqueous alkaline developer may be used for the positive resist film.

The spray nozzle 20 is mounted on an arm member 210 as shown in FIG. 2, with its outlet aimed downward. The spray nozzle moving mechanism 21 includes a vertical moving mechanism for moving the arm member 210 vertically (in the positive and negative Z-axis direction) with respect to the wafer W, and a horizontal moving mechanism for moving the arm member 210 horizontally (in the positive and negative X-axis direction) with respect to the wafer W. The vertical moving mechanism may simply be an air cylinder for moving the arm member 210 up and down, or may have various other configurations. The horizontal moving mechanism may include a drive motor and a drive belt for converting the torque of the drive motor to linear motion. The developing device 1 may also include a driving mechanism for moving the spray nozzle 20 in the longitudinal direction of the arm member 210 (the Y-axis direction).

Before the start of the rinsing process, the rinse nozzle 30 is raised from its standby pod 34 to the standby position shown in FIGS. 1 and 2. During rinsing, the rinse nozzle moves over the wafer W as indicated in FIG. 2, receives the rinse solution (e.g., pure water) under high pressure through the control valve 32 from the rinse solution supply 33, and sprays the solution downward from an outlet at its tip 30t. The rate of discharge of the rinse solution is adjusted by the control valve 32, which operates under control of the rinse solution spray controller 45 in the controller 40.

The rinse nozzle 30 is mounted on a rod-like arm member 310 as shown in FIG. 2, with its outlet aimed downward. The rinse nozzle moving mechanism 31 includes a mechanism for swiveling the arm member 310 horizontally in the X-Y plane, as shown. The rinse nozzle moving mechanism 31 may also include a mechanism for moving the arm member 310 in its longitudinal direction.

The rotation controller 41 that controls the operation of the rotational driving mechanism 14, the spray nozzle motion controller 42 that controls the operation of the spray nozzle moving mechanism 21, the rinse nozzle motion controller 43 that controls the operation of the rinse nozzle moving mechanism 31, the developer spray controller 44 that controls the operation of control valve 22, and the rinse solution spray controller 45 that controls the operation of control valve 32 may be separate units in the controller 40 as shown in FIG. 1. Alternatively, the controller 40 may include a central processing unit (CPU) such as a microprocessor, read-only memory (ROM) and other types of non-volatile memory, random-access memory, timer circuits, and input-output interfaces, and may implement the above control functions by reading and executing a program or an executable file in the non-volatile memory.

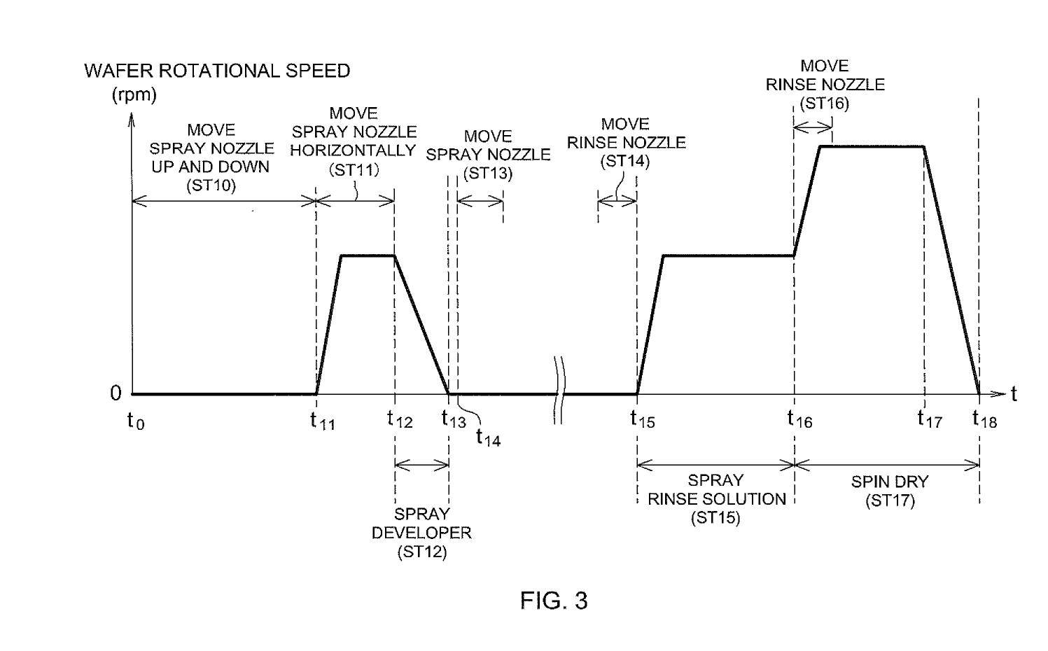

The operation of the developing device 1 will now be described with reference to FIG. 3, which shows an exemplary development sequence according to the first embodiment. In this graph, the horizontal axis indicates elapsed time (development sequence time), and the vertical axis indicates the rotational speed or spin rate of the wafer W in revolutions per minute (rpm).

In the initial state at time zero (t=t₀) the wafer W is stationary, the spray nozzle 20 is at its standby position above standby pod 24, and the rinse nozzle 30 is at its standby position above standby pod 34. The spray nozzle motion controller 42 starts the sequence by having the spray nozzle moving mechanism 21 move the spray nozzle 20 up and down (step ST10).

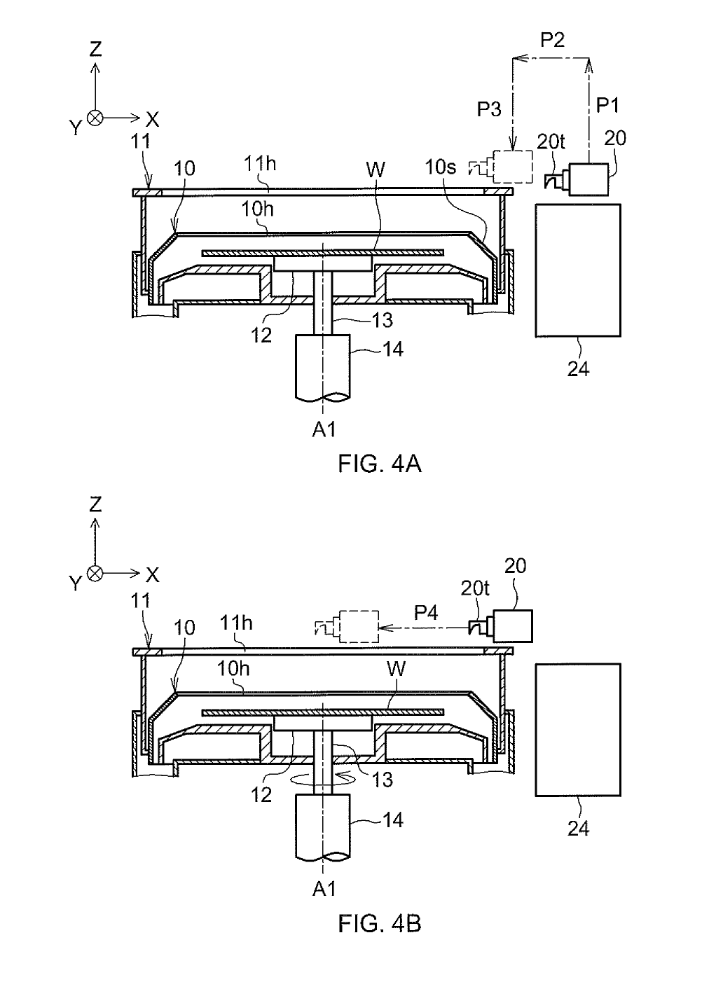

More specifically, as shown in FIG. 4A, the spray nozzle moving mechanism 21 moves the spray nozzle 20 vertically upward along a path P1 from the standby position to a first upper position. Next, the spray nozzle moving mechanism 21 moves the spray nozzle 20 horizontally toward the wafer W along a path P2 to a second upper position at which the outlet at the tip 20t of the spray nozzle 20 is positioned above the outer sloping surface 10s of the inner cup 10. The spray nozzle moving mechanism 21 then moves the spray nozzle 20 vertically downward along a path P3 to a lower position, at which the outlet at the tip 20t of the spray nozzle 20 is still positioned above the outer sloping surface 10s of the inner cup 10.

The up and down motions on paths P1 and P3 and the horizontal motion on path P2 all take place between time t₀ and time t₁₁ in FIG. 3. The paths are designed so that the spray nozzle 20 does not strike the outer cup 11. The first and second upper positions and lower position are all higher than the top rim of the outer cup 11 and thus higher than the wafer W. The second upper position is closer than the first upper position to the wafer W.

Next, the spray nozzle moving mechanism 21 moves the spray nozzle 20 horizontally along a path P4 shown in FIG. 4B until the tip 20t of the spray nozzle 20 is positioned at a spray position located above the central part of the wafer W (step ST11). The speed of travel on path 94 is a relatively low speed such as 100 mm/s.

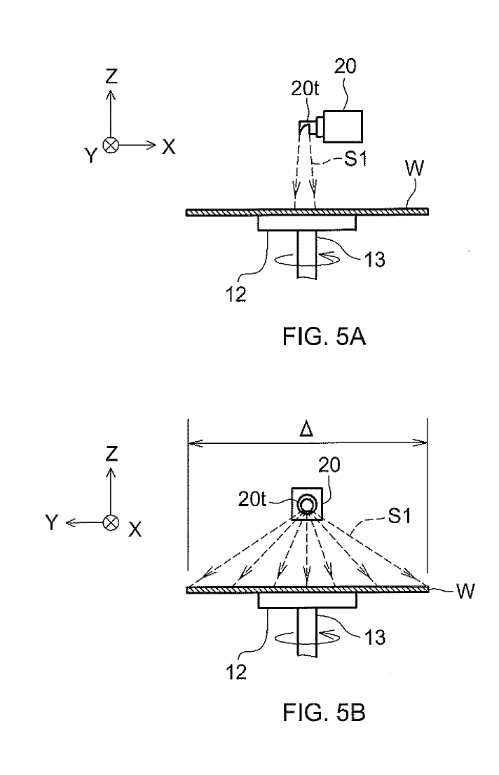

When the spray nozzle 20 reaches the lower position at the end of path 23 at time t₁₁ in FIG. 3, the rotation controller 41 commands the rotational driving mechanism 14 to start spinning the wafer W. After the rotational speed of the wafer W has reached a target rotational speed (e.g., 2,500 rpm) and stabilized and the spray nozzle 20 has reached its spray position over the center of the wafer, at time t₁₂ the developer spray controller 44 issues a command that opens the control valve 22. The spray nozzle 20 then sprays the developer from the outlet at the tip 20t onto the wafer W as shown in FIGS. 5A and 5B (step ST12).

FIG. 5A schematically illustrates the spray pattern of the developer S1 as seen looking in the Y-axis direction. FIG. 5B schematically illustrates the spray pattern of the developer S1 as seen looking in the X-axis direction. For clarity, the inner and outer cups 10, 11 are omitted in FIGS. 5A and 5B. As shown in FIG. 5B, the developer S1 spreads in a fan shape having substantially the same width Δ (referred to as the spray width) as the diameter of the wafer W. The developer S1 is sprayed onto the resist film on the wafer W. The spray width A can be adjusted by adjusting the height of the spray nozzle 20 above the wafer W and the flow rate of the developer. When the developer S1 reaches the wafer W, it is spread across the entire surface of the rapidly rotating wafer W by the action of centrifugal force.

The rotational driving mechanism 14 starts reducing the rotational speed of the wafer W at time t₁₂ and brings the rotation to a stop at time t₁₃. At time t₁₃, the developer spray controller 44 closes the control valve 22 and the spray nozzle 20 stops discharging the developer.

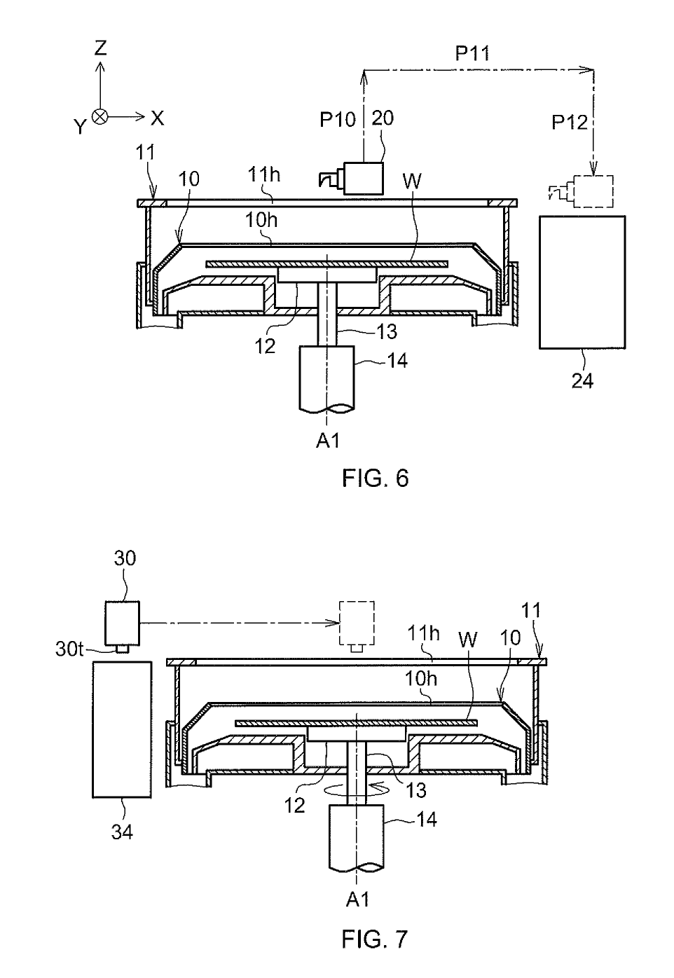

At a time t₁₄ when a prescribed interval (e.g., 0.5 to 1 second) has elapsed from time t₁₃, the spray nozzle motion controller 42 starts moving the spray nozzle 20 back from the spraying position to the standby position (step ST13). More specifically, as shown in FIG. 6, the spray nozzle motion controller 42 moves the spray nozzle 20 upward along a path P10, then horizontally along a path P11 to a position above the standby position, and finally downward along a path P12 to the standby position.

After another prescribed interval has elapsed, the rinse nozzle motion controller 43 swivels the rinse nozzle 30 to the spray position above the central part of the wafer W, as shown in FIG. 7 (step ST14 in FIG. 3). Next, at the time t₁₅ in FIG. 3 when the rinse nozzle 30 reaches the spray position, the rotation controller 41 commands the rotational driving mechanism 14 to start spinning the wafer W and increases the rotational speed of the wafer W until it reaches another target rotational speed (e.g., 2000 rpm). At the same time, the rinse solution spray controller 45 opens the rinse nozzle 30 to start spraying rinse solution (step ST15). The sprayed rinse solution is spread across the entire surface of the wafer W by the centrifugal force of the rapidly rotating wafer W.

Next, at time t₁₆, the rinse solution spray controller 45 closes control valve 32 and the rinse nozzle 30 stops spraying rinse solution. The rinse nozzle motion controller 43 now swivels the rinse nozzle 30 from the spray position to the standby position (step ST16). Over a period from time t₁₆ to time t₁₇ that lasts at least ten seconds and may last up to several tens of seconds, the rotation controller 41 increases the rotational speed of the wafer W to a higher target value (e.g., 4000 rpm) and spin dries the wafer W at this speed (step ST17). Then, at time t₁₈, the spinning stops and the sequence ends.

As described above, in this embodiment, the spray nozzle 20 is first moved upward along path P1 in FIG. 4A, then horizontally along path P2, and then downward to a position outside the outer circumference of the wafer W along path P3. If residual developer remains around the outlet of the spray nozzle 20 from a previous process, when the wafer W abruptly stops moving downward at the end of path P3, shock or inertia will usually cause the residual developer to drop off at this point, where it lands harmlessly on the outer sloping surface 10s of the inner cup 10 instead of adhering to the resist film on the wafer W. The spray nozzle motion controller 42 may cause the spray nozzle moving mechanism 21 to shake the spray nozzle 20 at this point to encourage the residual developer to drop off. The released residual developer may splash when it strikes the outer sloping surface 10s of the inner cup 10, but the tilt of this surface causes the residual developer to splash away from the wafer W.

When the spray nozzle 20 moves to the spray position along path P4 in FIG. 4B, it travels over the wafer W, but the slow rate of motion keeps further residual developer from being released by vibration or inertia. Accordingly, no residual developer drips onto or adheres to the wafer W before spraying begins. When spraying begins, any residual developer is that might still remain is diluted in the spray of fresh developer supplied from the developer supply 23, and its effect on the development process is negligible.

Before the nozzle 20 reaches its lower position and the wafer W begins to spin at time t₁₁ in FIG. 3, drops of residual developer might conceivably be released by shock or inertia at the end of the nozzle's horizontal travel on path P2 in FIG. 4A, and fall from this point at an angle onto the wafer, or splash onto the wafer from the top rim of the outer cup 11. Adhering to the resist film, these drops might cause local development defects at the points where they fall. Since the wafer is still stationary, however, the damage is localized, and drops of residual developer are not spread into streaks by centrifugal force, which would expand the range of damage. Such streaking of drops of residual developer is a problem in conventional developing devices that start spinning the wafer before the spray nozzle 20 leaves its standby position, causing residual developer that drops onto the wafer W to leave radial or concentric arc-like patterns of development defects.

Another way to remove residual developer from the outlet of the spray nozzle 20 is by a dummy dispensing process that discharges fresh developer from the spray nozzle 20 under high pressure to blow the residual developer out of the spray nozzle 20. Some conventional developing devices perform a dummy dispensing process just before or after every spraying operation, and other developing devices perform the dummy dispensing process after executing the development sequence a certain number of times. Besides eliminating residual developer that has deteriorated due to exposure to air, however, the dummy dispensing process also uses up fresh developer, which is problematic because it increases the manufacturing cost. The novel developing device 1 can greatly reduce the number of dummy dispensing processes or eliminate the need for dummy dispensing altogether, thereby reducing the semiconductor device manufacturing cost.

### Second Embodiment

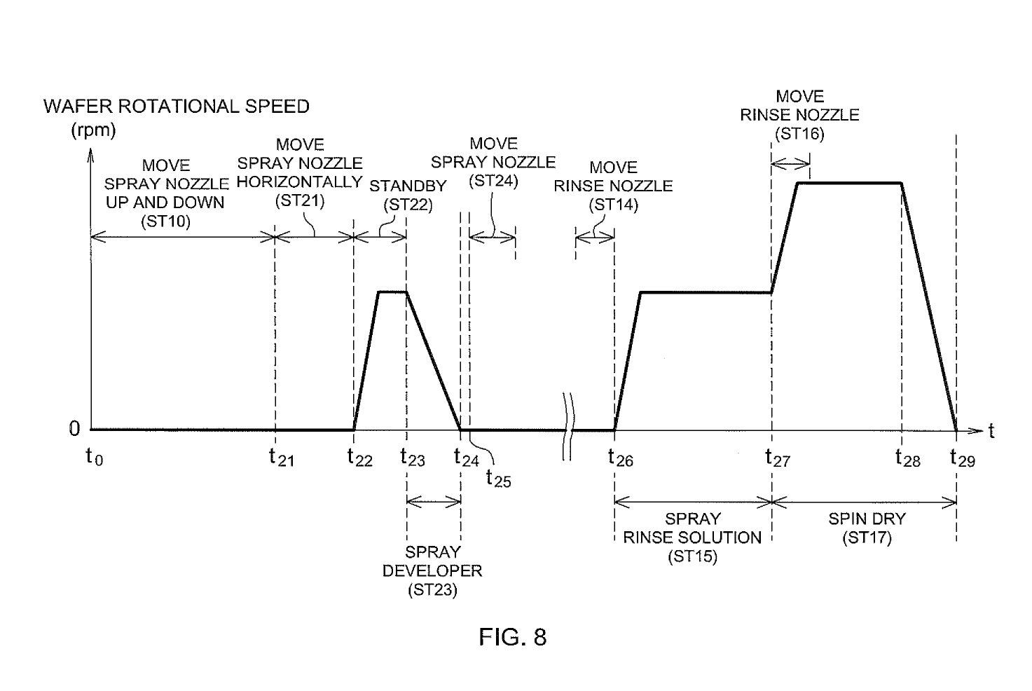

The developing device in the second embodiment has the same structure as the developing device 1 in the first embodiment, but employs a different development sequence, as shown by the exemplary sequence in FIG. 8.

As in the first embodiment, when the sequence starts, the spray nozzle moving mechanism 21 moves the spray nozzle 20 up and down (step ST10). More specifically, as shown in FIG. 4A, the spray nozzle moving mechanism 21 moves the spray nozzle 20 upward along path P1, horizontally along path P2, and then downward along path P3 to a position above the tilted surface 10s of the inner cup 10, outside the outer circumference of the wafer W.

Next, the spray nozzle moving mechanism 21 moves the spray nozzle 20 horizontally along path P4 in FIG. 4B to the spray position where the tip 20t of the spray nozzle 20 is above the central part of the wafer W (step ST21 in FIG. 8). As in the first embodiment, travel on path P4 is slow, lasting from time t₂₁ to time t₂₂ in FIG. 8. Differing from the first embodiment, the rotation controller 41 does not allow the wafer W to start spinning during this period in which the spray nozzle 20 is moving horizontally over the wafer W.

When the spray nozzle 20 reaches the spray position at time t₂₂, the rotational driving mechanism 14 starts spinning the wafer W under control of the rotation controller 41. The spray nozzle 20 waits at the spray position until the rotational speed of the wafer W reaches the target rotational speed (e.g., 2500 rpm) and the rotation has stabilized (step ST22). At time t₂₃, with the wafer spinning at high speed, the developer spray controller 44 causes the spray nozzle 20 to start spraying the developer onto the wafer W from the outlet at the tip 20t in the spray pattern shown in FIGS. 5A and 5B (step ST23). The rotational driving mechanism 14 now reduces the rotational speed of the wafer W until the rotation stops at time t₂₄, at which time the developer spray controller 44 causes the spray nozzle 20 to stop spraying. At time t₂₅, a prescribed interval (e.g., 0.5 to 1 second) after time t₂₄, the spray nozzle motion controller 42 causes the spray nozzle 20 to start moving from the spray position back to the standby position. This motion is carried out (step ST24) as shown in FIG. 6.

After the spray nozzle 20 returns to the standby position, a rinsing process is carried out as in the first embodiment. The rinse nozzle motion controller 43 causes the rinse nozzle 30 to swivel to the spray position above the central part of the wafer W (step ST14). At time t₂₆, the rotation controller 41 commands wafer rotation to start, and then spins the wafer W at high speed while the rinse solution spray controller 45 causes the rinse nozzle 30 to spray rinse solution from the outlet at its tip 30t (step ST15). At time t₂₇, the rinse solution spray controller 45 causes the rinse nozzle 30 to stop spraying the rinse solution, and the rinse nozzle motion controller 43 causes the rinse nozzle 30 to swivel from the spray position to the standby position (step ST16), Then the rotation controller 41 increases the spin rate of the wafer W to a higher speed and sustains this spin rate until time t₂₈, thereby spin drying the wafer (step ST17). The spinning stops and the sequence ends at time t₂₉.

As described above, according to the second embodiment, the wafer W remains stationary during the period from time t₂₁ to time t₂₂ in which the spray nozzle 20 travels over the wafer W from the lower position at the end of path P3 to the spray position. Accordingly, even if residual developer drips from the outlet at the tip 20t of the spray nozzle 20 during this period, the drops of residual developer are not spread by centrifugal force into radial or concentric arc-like patterns on the resist film, and any development faults that might occur are localized.

### Third Embodiment

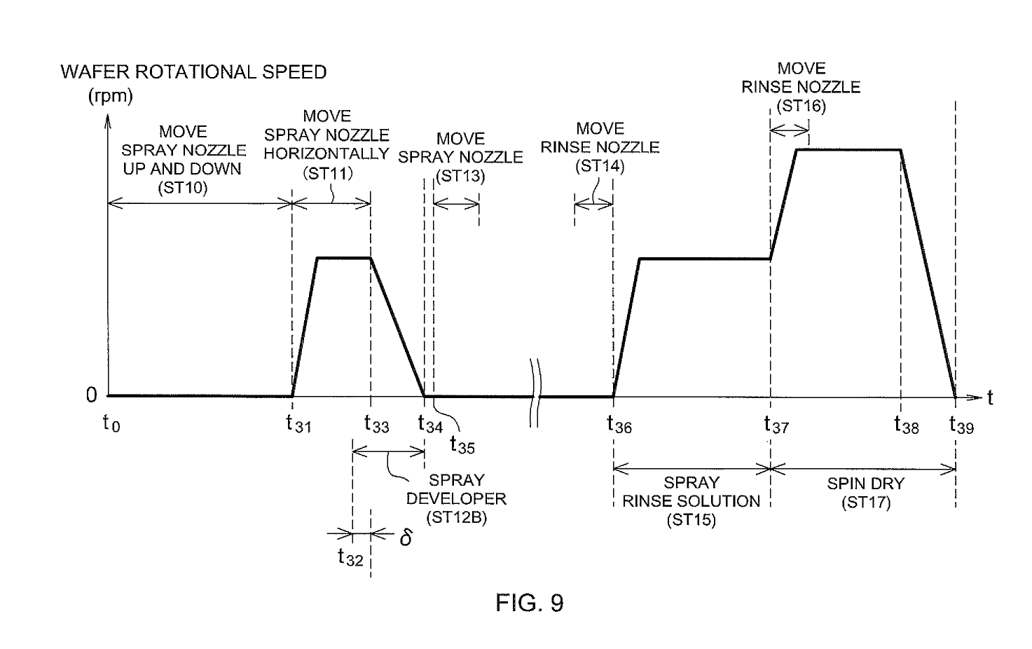

The developing device according to the third embodiment will now be described. The developing device in this embodiment has the same structure as the developing device 1 in the first embodiment, but employs a different development sequence, which will be described with reference to FIG. 9.

The sequence of steps in FIG. 9 is the same as in the first embodiment (FIG. 3) except that the developer spray controller 44 starts the spraying of developer from the tip 20t of the spray nozzle 20 (step ST12B) at a time t₃₂ while the spray nozzle 20 is still moving from the lower position toward the spray position. Time t₃₂ is offset by an interval δ (0.5 second, for example) from the time t₃₃ at which the spray nozzle 20 is programmed to reach the spray position. Times t₃₃ to t₃₉ in FIG. 9 correspond to times t₁₂ to t₁₈ in FIG. 3.

In the third embodiment, even if residual developer still remains around the outlet at the tip 20t of the spray nozzle 20 after the spray nozzle leaves the lower position, just before this residual developer might be released by shock or inertia caused when the spray nozzle 20 halts at the spray position and might drip onto the wafer W, the spray nozzle 20 starts spraying fresh developer at high pressure. This prevents the occurrence of development faults due to the adherence of the residual developer to the wafer W before the arrival of fresh developer.

The offset interval δ may be set to any value, provided the spraying of fresh developer onto the wafer starts at an acceptable position not greatly distant from the center of the wafer W.

Those skilled in the art will recognize that further embodiments and variations are possible within the scope of the invention, which is defined in the appended claims.

What is claimed is:

1. A substrate processing device, comprising:
a supporting member for supporting a substrate coated with a film;
a rotational driving unit for spinning the substrate;
a spray nozzle for spraying a liquid chemical agent for processing the film;
a nozzle moving mechanism for moving the spray nozzle horizontally and vertically relative to the supporting member;
a spray nozzle motion controller for controlling the nozzle moving mechanism;
a spray controller for causing the liquid chemical agent to be sprayed from the spray nozzle toward the film; and
a rotational controller for controlling the rotational driving unit; wherein
the spray nozzle motion controller causes the nozzle moving mechanism to move the spray nozzle horizontally from a first upper position higher than but not overlying the substrate to a second upper position higher than but not overlying the substrate, the second upper position being closer than the first upper position to the substrate, then move the spray nozzle vertically from the second upper position to a lower position lower than the second upper position but higher than the substrate, and then move the spray nozzle horizontally from the lower position to a spray position vertically above the substrate.

2. The substrate processing device of claim 1, wherein the rotational driving unit holds the substrate stationary until the spray nozzle reaches the lower position.

3. The substrate processing device of claim 2, wherein the rotational driving unit starts spinning the substrate immediately after the spray nozzle reaches the lower position.

4. The substrate processing device of claim 3, wherein the spray controller causes the spray nozzle to start discharging the liquid chemical agent before the spray nozzle reaches the spray position.

5. The substrate processing device of claim 2, wherein the rotational driving unit starts spinning the substrate after the spray nozzle reaches the spray position.

6. The substrate processing device of claim 1, further comprising:
a baffle surrounding the substrate, the baffle having a tilted surface sloping downward and away from the substrate, wherein:
the lower position is disposed vertically above the tilted surface.

7. The substrate processing device of claim 1, wherein the spray controller causes the spray nozzle to start discharging the liquid chemical agent toward the film after the substrate reaches a target rotational speed.

8. The substrate processing device of claim 1, wherein the nozzle moving mechanism also moves the spray nozzle vertically upward from a standby position to the first upper position, the standby position not overlying the substrate.

9. The substrate processing device of claim 8, further comprising:
an annular member surrounding the substrate, wherein:
the annular member has an upper rim disposed at a position higher than the standby position and lower than the first upper position.

10. The substrate processing device of claim 1, wherein:
the film to be processed is a photosensitive resin film that has been selectively exposed to light; and
the liquid chemical agent is a developer for dissolving portions of the photosensitive resin film depending on whether or not the portions have been exposed to the light.

11. The substrate processing device of claim 10, wherein the substrate is a semiconductor wafer.

12. A substrate processing method for use in a substrate processing device having a spray nozzle for discharging a liquid chemical agent for processing a film on a substrate, a nozzle moving mechanism for moving the spray nozzle vertically and horizontally relative to the substrate, and a rotational driving unit for spinning the substrate, the substrate processing method comprising:
causing the nozzle moving mechanism to move the spray nozzle horizontally from a first upper position not overlying the substrate to a second upper position not overlying the substrate, the second upper position being closer than the first upper position to the substrate;
causing the nozzle moving mechanism to move the spray nozzle vertically from the second upper position to a lower position that is lower than the second upper position and higher than the substrate; and
causing the nozzle moving mechanism to move the spray nozzle horizontally from the lower position to a spray position directly over the substrate.

13. The substrate processing method of claim 12, further comprising causing the rotational driving unit to hold the substrate stationary until the spray nozzle reaches the lower position.

14. The substrate processing method of claim 13, further comprising causing the rotational driving unit to start spinning the substrate immediately after the spray nozzle reaches the lower position.

15. The substrate processing method of claim 14, further comprising causing the spray nozzle to start discharging the liquid chemical agent before the spray nozzle reaches the spray position.

16. The substrate processing method of claim 13, further comprising causing the spray nozzle to start discharging the liquid chemical agent after the spray nozzle reaches the spray position.

17. The substrate processing method of claim 12, wherein the substrate processing device also has a baffle surrounding the substrate, the baffle has a tilted surface sloping downward and away from the substrate, and the lower position is disposed vertically above the tilted surface.

18. The substrate processing method of claim 12, further comprising causing the spray nozzle to start discharging the liquid chemical agent toward the film after the substrate reaches a target rotational speed.

19. The substrate processing method of claim 12, further comprising causing the nozzle moving mechanism to move the spray nozzle upward from a standby position to the first upper position, the standby position not overlying the substrate.
